(19) United States
(12) Patent Application Publication
(10) Pub. No.: US 2006/0106911 A1
(43) Pub. Date: May 18, 2006

(54) Concurrent PCI express with sDVO

(76) Inventors: James S. Chapple, Chandler, AZ (US); Sylvia J. Downing, El Dorado Hills, CA (US); Scott Janus, Rocklin State, CA (US); Katen A. Shah, Folsom, CA (US); Patrick A. Smith, Cameron Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/976,488

(22) Filed: Oct. 29, 2004

(51) Int. Cl. G06F 15/16

(52) U.S. Cl. 709/200

(57) ABSTRACT

A method, apparatus, and system are disclosed. In one embodiment the method comprises transmitting Peripheral Component Interconnect (PCI) Express protocol data on a first set of one or more lanes of a link and concurrently transmitting non-PCI Express protocol data on a second set of one or more lanes of the link.

### FIELD OF THE INVENTION

The invention relates to serial interface protocols and transmissions. More specifically, the invention relates to concurrently transmitting PCI Express protocol data and sDVO protocol data over a PCI Express serial link.

### BACKGROUND OF THE INVENTION

The PCI Express™ interface protocol, as defined by the PCI Express Base Specification, Revision 1.0a (Apr. 15, 2003), is fast becoming a widely used standard across the computer industry for a high-speed data communication link between a chipset and a graphics peripheral card. In many computer systems, the graphics processor has been integrated within the memory controller hub (MCH) component of the chipset. Many computers need to display very detailed graphics that have been rendered by the graphics processor as well as high-resolution video from a separate external video input card due to the increased complexity of the content that a computer user views regularly. Under current technology, computer systems with integrated graphics processors in the MCH may send rendered graphics content to an external port across a PCI Express link that will be displayed on a monitor. These computer systems may also send/receive video content across a PCI Express link to/from an external peripheral card that plugs into the PCI Express port. The peripheral card may support any number of video formats and can in turn render the video content to a monitor in a supported format.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of one embodiment of a computer system including a PCI Express serial link.

FIG. 2A is a block diagram of one embodiment of the graphics/memory controller hub (GMCH) and graphics peripheral device subsystem.

FIG. 2B is a diagram of one embodiment of one lane of a differential serial link.

FIG. 3A is a block diagram of one embodiment of the GMCH and graphics peripheral device subsystem.

FIG. 3B is a block diagram of another embodiment of the GMCH and graphics peripheral device subsystem.

FIG. 3C is a block diagram of yet another embodiment of the GMCH and graphics peripheral device subsystem.

FIG. 4 is a block diagram of one embodiment of GMCH circuitry utilized to select the data/protocol output onto the PCI Express link.

FIG. 5 is a block diagram of another embodiment of GMCH circuitry utilized to select the data/protocol output onto the PCI Express link.

FIG. 6 is a flow diagram of one embodiment of a process for simultaneously transmitting PCI Express data and non-PCI Express data on a link.

FIG. 7 is a flow diagram of one embodiment of a process for selecting a protocol to be transmitted on a link.

FIG. 8 is a flow diagram of another embodiment of a process for selecting a protocol to be transmitted on a link.

### DETAILED DESCRIPTION OF THE INVENTION

Embodiments of a method to transmit PCI Express protocol data and sDVO protocol data concurrently over a PCI Express serial link are disclosed. In the following description, numerous specific details are set forth. However, it is understood that embodiments may be practiced without these specific details. In other instances, well-known elements, specifications, and protocols have not been discussed in detail in order to avoid obscuring the present invention.

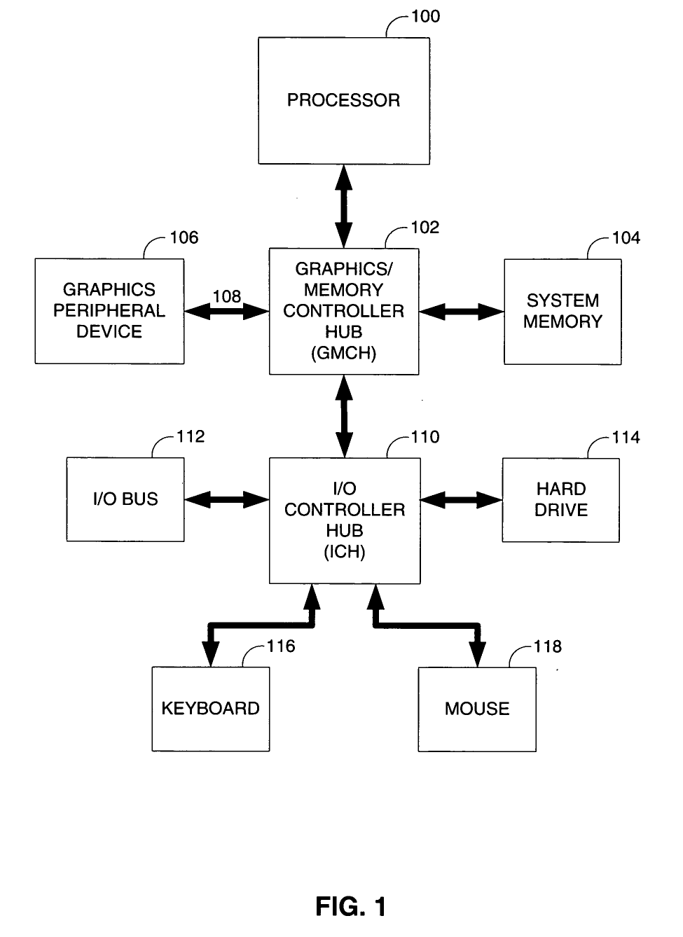

FIG. 1 is a block diagram of one embodiment of a computer system including a PCI Express serial link. The computer system includes a processor 100, a graphics/memory controller hub (GMCH) 102, and an I/O controller hub (ICH) 110. In one embodiment, the GMCH 102 may include a memory controller hub as well as an internal graphics processor. In another embodiment, the GMCH 102 and the ICH 110 comprise a chipset. In one embodiment, the processor 100 is coupled to the GMCH 102 via a host bus and to system memory 104. System memory may comprise one or more of synchronous dynamic random access memory (SDRAM), Double Data Rate SDRAM (DDRSDRAM), or one of many other formats of main system memory. In one embodiment, the GMCH 102 is also coupled to a graphics peripheral device 106 by some form of interconnect 108. In one embodiment, the graphics peripheral device 106 is a Peripheral Component Interconnect (PCI) Express graphics card. In this embodiment, the interconnect 108, which connects the PCI Express graphics card to the GMCH 102, is a PCI Express point-to-point serial link. Additionally, references in the specification to embodiments of a PCI Express link (or “link” or “serial link”) refer specifically to one or more PCI Express full-duplex serial lanes, the one or more lanes comprising the link. The link may also be referred to as a “bus,” although “link” is a more common term used to refer to serial interconnects. Alternately, in yet another embodiment, the chipset comprises a memory controller hub (MCH), instead of a GMCH, and an ICH. In this embodiment, the graphics controller would be located on the graphics peripheral device 106. In one embodiment, the ICH 110 is coupled to an I/O bus 112, a hard drive 114, a keyboard controller 116, and a mouse controller 118. In different embodiments, the ICH 110 may also be coupled to any number of I/O devices, buses, and/or other controllers.

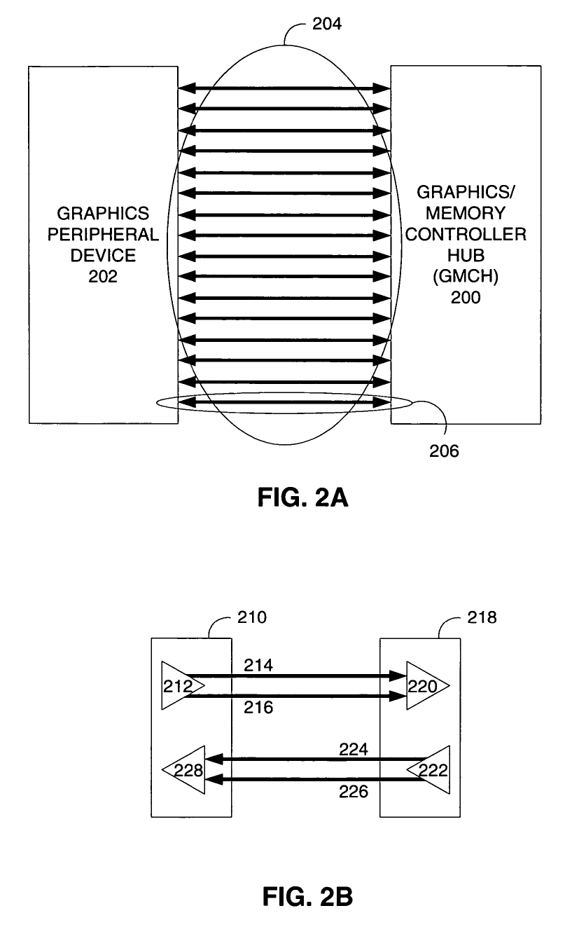

FIG. 2A is a block diagram of one embodiment of the GMCH and graphics peripheral device subsystem. The GMCH 200 is coupled to the graphics peripheral device 202 by a link 204. In one embodiment, the link 204 is a multi-lane, full-duplex differential serial link. Each line shown within link204 comprises one differential serial lane. FIG. 2B is a diagram of one embodiment of one lane of a differential serial bus (for example, lane 206 from FIG. 2A). One lane in a full-duplex (i.e. 2-way) differential serial connection between two devices requires four wires. Device 1 210 has a transmitter 212 that sends data serially on two wires 214 and 216. The two wires comprise a differential signal pair. The first wire 214 sends the signal itself and the second wire sends the inverse of the signal. Device 2 218 has a receiver 220 that receives the signals from the differential signal pair (214 and 216) transmitted by device 1 210. Additionally, a second differential signal pair comprising wires 224 and 226 is utilized to send signals from the device 2 218 transmitter 222 to the device 1 210 receiver 228. This set of four wires comprises one lane of a full-duplex differential serial link.

Furthermore, a multi-lane differential serial link has more than one four-wire lane between two devices. Thus, in one embodiment, bus 204 in FIG. 2A is a standard PCI Express serial bus that has 16 full-duplex differential serial lanes with a total of 64 wires. This version is commonly referred to as a PCI Express x16 link.

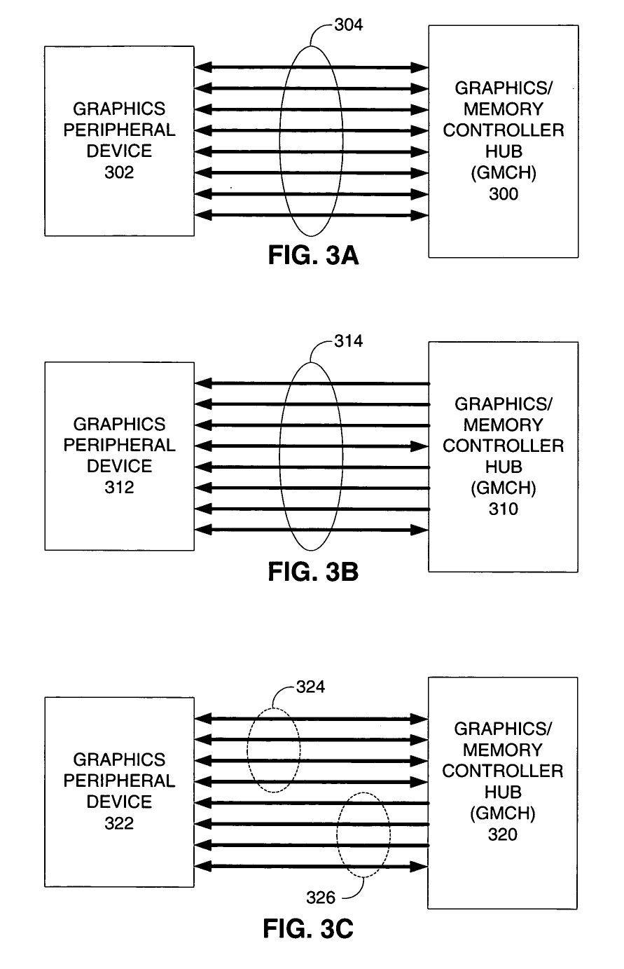

To simplify by way of example, FIG. 3A is a block diagram of another embodiment of the GMCH and graphics peripheral device subsystem where link 304 is a PCI Express serial link with eight full-duplex differential serial lanes with a total of 16 wires. Thus, each link lane shown in FIG. 3A (of which there are eight lanes for link 304) depicts four individual wires that comprise one lane of a full-duplex differential serial link. In one embodiment, the GMCH 300 and the graphics peripheral device 302 communicate with each other using PCI Express protocol over link 304. When operating in PCI Express protocol mode both the GMCH 300 and the graphics peripheral device 302 send and receive data over all lanes of link 304.

FIG. 3B is a block diagram of another embodiment of the GMCH and graphics peripheral device subsystem where the GMCH 310 communicates with the graphics peripheral device 312 using a serial Digital Video Output (sDVO) bus protocol, as defined by the sDVO Specification version 0.95 (Apr. 30, 2004). sDVO is a bus protocol that may be transmitted using the PCI Express electricals and pins of the PCI Express graphics port of the GMCH 200, which connects to the PCI Express serial link. sDVO allows for video and graphics display to be transmitted to an external chip that may support TV, digital visual interface (DVI), low voltage differential signaling (LVDS), CRT, or some other video or display standard. In one embodiment, when sDVO is active on the PCI Express graphics link of the GMCH the PCI Express functionality is disabled. In this embodiment, the GMCH sends data to the graphics peripheral device 312 over all but one lane of link 314. sDVO requires one bi-directional lane per port so the graphics peripheral device 312 may send interrupt, clocking, stall, or configuration data to the GMCH 310. An sDVO port consists of four lanes. Thus in the example shown in FIG. 3B, there are eight total lanes which are comprised of two sDVO ports that each consist of three output lanes and one bi-directional lane. Graphics traffic is one-way, thus there is no display data being sent from the graphics peripheral device 312 to the GMCH 310. Additionally, in one embodiment, there is an additional lane apart from the lanes shown used for I2C (Inter-Integrated Circuit traffic, as defined by Philips 1²C specification, version 2.1 (January 2000)). The I2C lane can be shared among both sDVO ports.

FIG. 3C is a block diagram of yet another embodiment of the GMCH and graphics peripheral device subsystem where the GMCH 320 and the graphics peripheral device 322 communicate with each other utilizing both PCI Express protocol and sDVO protocol. In this embodiment, the GMCH 320 and graphics peripheral device 322 communicate with each other in PCI Express protocol utilizing the first through fourth link lanes 324 and the GMCH 320 communicates to the graphics peripheral device in sDVO protocol utilizing the fifth through eighth link lanes 326. Therefore, in this embodiment, both protocols are transmitted across the link in separate lanes simultaneously. In the embodiment in which the link is a PCI Express x16 link (16-lane link), the link may have eight lanes dedicated for PCI Express protocol data and eight lanes dedicated for sDVO protocol data.

In another embodiment, the PCI Express x16 link may have eight lanes dedicated for PCI Express protocol data and eight lanes dedicated for non-PCI Express protocol data. The non-PCI Express protocol data may be any protocol that is compatible with the installed GMCH and graphics peripheral device, such as UDI, currently defined by the UDI Specification, Revision 0.71 (Aug. 6, 2004). In yet another embodiment, the PCI Express x16 link can have one or more lanes dedicated to PCI Express protocol data and one or more lanes dedicated to non-PCI Express protocol data. Thus, in this embodiment, there may be 4 lanes dedicated to PCI Express protocol data and 12 lanes dedicated to non-PCI Express protocol data. In another embodiment, there may be 12 lanes dedicated to PCI Express protocol data and 4 lanes dedicated to non-PCI Express protocol data. In other embodiments, there may be any number of lanes dedicated to PCIExpress protocol data and non-PCI Express protocol data providing that the total number of lanes do not add up to more than the total number of lanes accessible on the link and each protocol has at least one lane.

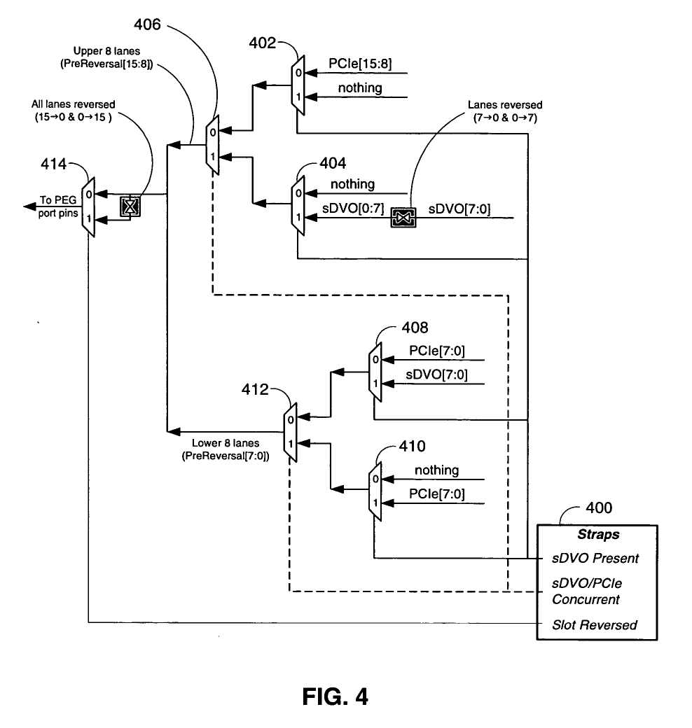

FIG. 4 is a block diagram of one embodiment of GMCH circuitry utilized to select the data/protocol output onto the PCI Express link. In one embodiment, several selectable strap options 400 are available to modify the output of the GMCH. In other embodiments, embedded software, firmware, or hardware circuitry is utilized in lieu of selectable strap options to modify the output of the GMCH. In one embodiment, inputs into the circuit other than the strap options 400 are PCI Express[15:0] data and sDVO[7:0] data. Note that some or all of the sDVO or PCI Express data may be enabled on the output lanes. For instance, of the sDVO[7:0] data enabled through the multiplexers, only sDVO[7:4] or sDVO[3:0] may be enabled on the output drivers. Table 1 shows the set of configurations in one embodiment based on the strap options 400. Configurations 1-6 are valid and configurations 7 and 8 are not valid.

TABLE 1
GMCH Output Configurations (Straps: Selected = YES, Not Selected = NO)

| | | | | sDVO/PCI Express |
|---|---|---|---|---|
| Configuration | Description | Slot Reversed | sDVO Present | Concurrent |
| 1 | PCI Express not reversed | NO | NO | NO |
| 2 | PCI Express reversed | YES | NO | NO |
| 3 | sDVO not reversed | NO | YES | NO |
| 4 | sDVO reversed | YES | YES | NO |
| 5 | sDVO and PCI Express not reversed | NO | YES | YES |
| 6 | sDVO and PCI Express reversed | YES | YES | YES |
| 7 | Not valid | YES | NO | YES |
| 8 | Not valid | NO | NO | YES |

Configuration 1 allows the GMCH to output PCI Express protocol data in standard format (i.e. not reversed) to the PCI Express graphics (PEG) port. No strap (Slot Reversed, sDVO Present, and sDVO/PCI Express Concurrent) is selected in configuration 1. Thus, in this configuration every multiplexer (MUX) in FIG. 4 outputs their zero inputs (“0”). MUX 402 outputs PCI Express[15:8] data. MUX 404 outputs nothing. MUX 406 outputs PCI Express[15:8] data. MUX 408 outputs PCI Express[7:0] data. MUX 410 outputs nothing. MUX 412 outputs PCI Express[7:0] data. Finally, MUX 414 outputs PCI Express[15:0] data in standard format to the PEG port that is coupled to the PCI Express x16 link.

Configuration 2 allows the GMCH to output PCI Express protocol data in reversed format to the PEG port. Reversed format output data is the exact same data with the lanes completely reversed. Thus, on a 16-lane link, the output of 15:0 would instead be output as 0:15. In configuration 2 the Slot Reversed strap is selected but the sDVO Present strap and sDVO/PCI Express Concurrent strap are not selected. Thus, in this configuration MUX 402 outputs PCI Express[15:8] data. MUX 404 outputs nothing. MUX 406 outputs PCI Express[15:8] data. MUX 408 outputs PCI Express[7:0] data. MUX 410 outputs nothing. MUX 412 outputs PCI Express[7:0] data. Finally, MUX 414 outputs PCI Express[0:15] data to the PEG port that is coupled to the PCI Express x16 link.

Configuration 3 allows the GMCH to output sDVO protocol data in standard format to the PEG port. In this configuration the sDVO Present strap is selected but the Slot Reversed strap and sDVO/PCI Express Concurrent strap are not selected. Thus, in this configuration MUX 402 outputs nothing. MUX 404 outputs sDVO[0:7] data. MUX 406 outputs nothing. MUX 408 outputs sDVO [7:0] data. MUX 410 outputs PCI Express[7:0] data. MUX 412 outputs sDVO[7:0] data. Finally, MUX 414 outputs sDVO[7:0] data on lanes [7:0] and nothing on lanes [15:8] to the PEG port that is coupled to the PCI Express x16 link.

Configuration 4 allows the GMCH to output sDVO protocol data in reversed format to the PEG port. In this configuration the sDVO Present strap and the Slot Reversed strap are selected but the sDVO/PCI Express Concurrent strap is not selected. Thus, in this configuration MUX 402 outputs nothing. MUX 404 outputs sDVO[0:7] data. MUX 406 outputs nothing. MUX 408 outputs sDVO [7:0] data. MUX 410 outputs PCI Express[7:0] data. MUX 412 outputs sDVO[7:0] data. Finally, MUX 414 outputs sDVO[7:0] data on lanes [8:15] to the PEG port that is coupled to the PCI Express x16 link.

Configuration 5 allows the GMCH to output PCI Express protocol data and sDVO protocol data in standard format to the PEG port. In this configuration the sDVO Present strap and the sDVO/PCI Express Concurrent strap are selected but the Slot Reversed strap is not selected. Thus, in this configuration MUX 402 outputs nothing. MUX 404 outputs sDVO[0:7] data. MUX 406 outputs sDVO[0:7] data. MUX 408 outputs sDVO [7:0] data. MUX 410 outputs PCI Express[7:0] data. MUX 412 outputs PCI Express[7:0] data. Finally, MUX 414 outputs PCI Express[7:0] data on lanes [7:0] and sDVO[0:7] data on lanes [15:8] to the PEG port that is coupled to the PCI Express x16 link.

Configuration 6 allows the GMCH to output PCI Express protocol data and sDVO protocol data in reverse format to the PEG port. In this configuration all straps are selected (Slot Reversed, sDVO Present, and sDVO/PCI Express Concurrent). Thus, in this configuration MUX 402 outputs nothing. MUX 404 outputs sDVO[0:7] data. MUX 406 outputs sDVO[0:7] data. MUX 408 outputs sDVO [7:0] data. MUX 410 outputs PCI Express[7:0] data. MUX 412 outputs PCI Express[7:0] data. Finally, MUX 414 outputs sDVO[7:0] data on lanes [7:0] and PCI Express[0:7] data on lanes [15:8] to the PEG port that is coupled to the PCI Express x16 link.

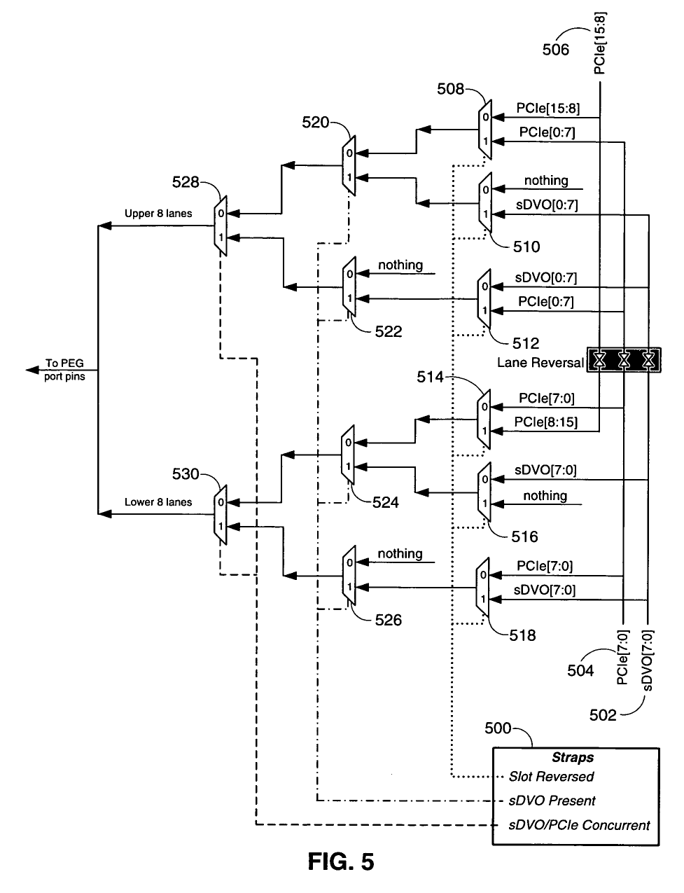

FIG. 5 is a block diagram of another embodiment of GMCH circuitry utilized to select the data/protocol output onto the PCI Express link. Several selectable strap options 500 are available to modify the output of the GMCH. The inputs into the circuit other than the strap options 500 are sDVO[7:0] data 502, PCI Express[7:0] data 504, and PCI Express[15:8] data 506. Table 1 above shows the set of allowable configurations based on the strap options 500.

Configuration 1 allows the GMCH to output PCI Express protocol data in standard format to the PEG port. No strap (Slot Reversed, sDVO Present, and sDVO/PCI Express Concurrent) is selected in configuration 1. MUX 508 outputs PCI Express[15:8] data. MUX 510 outputs nothing. MUX 512 outputs sDVO[0:7] data. MUX 514 outputs PCI Express[7:0] data. MUX 516 outputs sDVO[7:0] data. MUX 518 outputs PCI Express[7:0] data. MUX 520 outputs PCI Express[15:8] data. MUX 522 outputs nothing. MUX 524 outputs PCI Express[7:0] data. MUX 526 outputs nothing. MUX 528 outputs PCI Express[15:8] data. Finally, MUX 530 outputs PCI Express[7:0] data. Thus, in configuration 1 PCI Express[15:8] data is output onto lanes [15:8] and PCI Express[7:0] data is output onto lanes [7:0] to the PEG port that is coupled to the PCI Express x16 link.

Configuration 2 allows the GMCH to output PCI Express protocol data in reverse format to the PEG port. In configuration 2 the Slot Reversed strap is selected but the sDVO Present strap and sDVO/PCI Express Concurrent strap are not selected. MUX 508 outputs PCI Express[0:7] data. MUX 510 outputs sDVO[0:7] data. MUX 512 outputs PCI Express[0:7] data. MUX 514 outputs PCI Express[8:15] data. MUX 516 outputs nothing. MUX 518 outputs sDVO[7:0] data. MUX 520 outputs PCI Express[0:7] data. MUX 522 outputs nothing. MUX 524 outputs PCI Express[8:15] data. MUX 526 outputs nothing. MUX 528 outputs PCI Express[0:7] data. Finally, MUX 530 outputs PCI Express[8:15] data. Thus, in configuration 2 PCI Express[0:7] data is output onto lanes [15:8] and PCI Express[8:15] data is output onto lanes [7:0] to the PEG port that is coupled to the PCI Express x16 link.

Configuration 3 allows the GMCH to output sDVO protocol data in standard format to the PEG port. In this configuration the sDVO Present strap is selected but the Slot Reversed strap and sDVO/PCI Express Concurrent strap are not selected. MUX 508 outputs PCI Express[15:8] data. MUX 510 outputs nothing. MUX 512 outputs sDVO[0:7] data. MUX 514 outputs PCI Express[7:0] data. MUX 516 outputs sDVO[7:0] data. MUX 518 outputs PCI Express[7:0] data. MUX 520 outputs nothing. MUX 522 outputs sDVO[0:7] data. MUX 524 outputs sDVO[7:0] data. MUX 526 outputs PCI Express[7:0] data. MUX 528 outputs nothing. Finally, MUX 530 outputs sDVO[7:0] data. Thus, in configuration 3 nothing is output onto lanes [15:8] and sDVO[7:0] data is output onto lanes [7:0] to the PEG port that is coupled to the PCI Express x16 link.

Configuration 4 allows the GMCH to output sDVO protocol data in reversed format to the PEG port. In this configuration the sDVO Present strap and the Slot Reversed strap are selected but the sDVO/PCI Express Concurrent strap is not selected. MUX 508 outputs PCI Express[0:7] data. MUX 510 outputs sDVO[0:7] data. MUX 512 outputs PCI Express[0:7] data. MUX 514 outputs PCI Express[8:15] data. MUX 516 outputs nothing. MUX 518 outputs sDVO[7:0] data. MUX 520 outputs sDVO[0:7] data. MUX 522 outputs PCI Express[0:7] data. MUX 524 outputs nothing. MUX 526 outputs sDVO[7:0] data. MUX 528 outputs sDVO[0:7] data. Finally, MUX 530 outputs nothing. Thus, in configuration 4 sDVO[0:7] data is output onto lanes [15:8] and nothing is output onto lanes [7:0] to the PEG port that is coupled to the PCI Express x16 link.

Configuration 5 allows the GMCH to output PCI Express protocol data and sDVO protocol data in standard format to the PEG port. In this configuration the sDVO Present strap and the sDVO/PCI Express Concurrent strap are selected but the Slot Reversed strap is not selected. MUX 508 outputs PCI Express[15:8] data. MUX 510 outputs nothing. MUX 512 outputs sDVO[0:7] data. MUX 514 outputs PCI Express[7:0] data. MUX 516 outputs sDVO[7:0] data. MUX 518 outputs PCI Express[7:0] data. MUX 520 outputs nothing. MUX 522 outputs sDVO[0:7] data. MUX 524 outputs sDVO[7:0] data. MUX 526 outputs PCI Express[7:0] data. MUX 528 outputs sDVO[0:7] data. Finally, MUX 530 outputs PCI Express[7:0] data. Thus, in configuration 5 sDVO[0:7] data is output onto lanes [15:8] and PCI Express[7:0] data is output onto lanes [7:0] to the PEG port that is coupled to the PCI Express x16 link.

Lastly, configuration 6 allows the GMCH to output PCI Express protocol data and sDVO protocol data in reverse format to the PEG port. In this configuration all straps are selected (Slot Reversed, sDVO Present, and sDVO/PCI Express Concurrent). MUX 508 outputs PCI Express[0:7] data. MUX 510 outputs sDVO[0:7] data. MUX 512 outputs PCI Express[0:7] data. MUX 514 outputs PCI Express[8: 15] data. MUX 516 outputs nothing. MUX 518 outputs sDVO[7:0] data. MUX 520 outputs sDVO[0:7] data. MUX 522 outputs PCI Express[0:7] data. MUX 524 outputs nothing. MUX 526 outputs sDVO[7:0] data. MUX 528 outputs PCI Express[0:7] data. Finally, MUX 530 outputs sDVO[7:0] data. Thus, in configuration 6 PCI Express[0:7] data is output onto lanes [15:8] and sDVO[7:0] data is output onto lanes [7:0] to the PEG port that is coupled to the PCI Express x16 link. Again, configurations 7 and 8 shown in Table 1 are not valid.

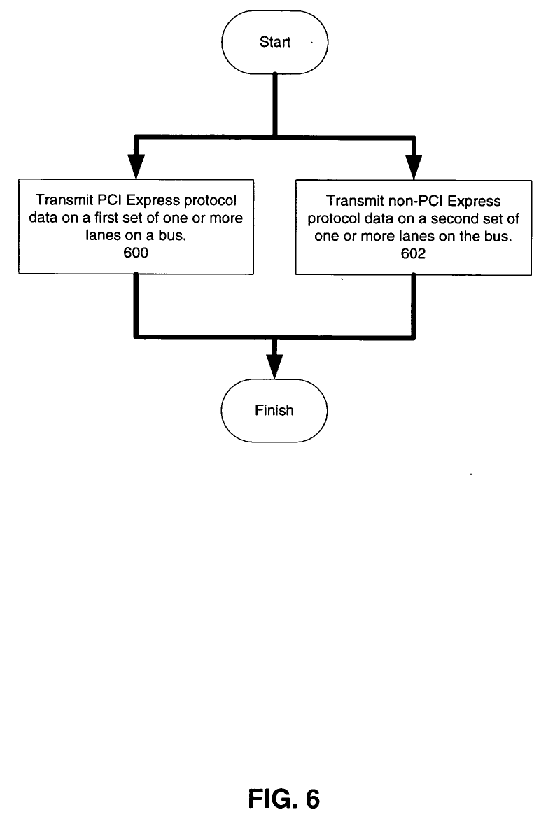

FIG. 6 is a flow diagram of one embodiment of a process for simultaneously transmitting PCI Express data and non-PCI Express data on a link. The process is performed by processing logic that may comprise hardware (circuitry, dedicated logic, etc.), software (such as is run on a general purpose computer system or a dedicated machine), or a combination of both. Referring to FIG. 6, the process begins by processing logic transmitting PCI Express protocol data on a first set of one or more lanes on a link (processing block 600). Simultaneously, processing logic also transmits non-PCI Express protocol data on a second set of one or more lanes on the link (processing block 602) and the process is finished. In another embodiment, processing logic receives the PCI Express protocol data on a first set of one or more lanes on a link. Simultaneously, processing logic also receives non-PCI Express protocol data on a second set of one or more lanes on the link and the process is finished. In one embodiment, the link may be a PCI Express x16 link. In another embodiment, the link may have eight lanes dedicated for PCI Express protocol data and eight lanes dedicated for non-PCI Express protocol data. In yet another embodiment, the PCI Express x16 link can have one or more lanes dedicated to PCI Express protocol data and one or more lanes dedicated to non-PCI Express protocol data. Thus, in this embodiment, any number of lanes may be dedicated to PCI Express protocol data and non-PCI Express protocol data providing that the total number of lanes don't add up to more than the total number of lanes accessible on the link and each protocol has at least one lane.

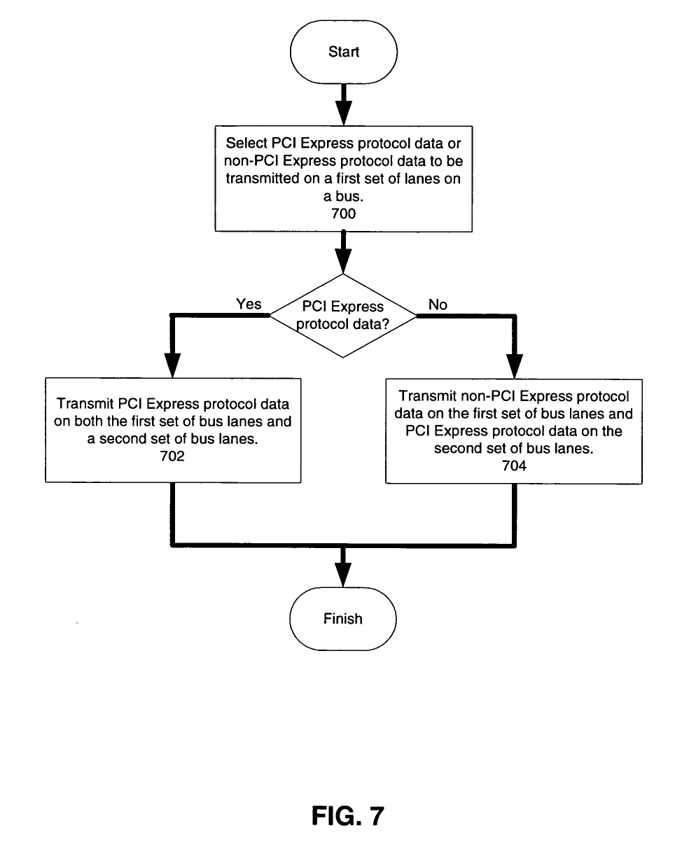

FIG. 7 is a flow diagram of one embodiment of a process for selecting a protocol to be transmitted on a link. The process is performed by processing logic that may comprise hardware (circuitry, dedicated logic, etc.), software (such as is run on a general purpose computer system or a dedicated machine), or a combination of both. Referring to FIG. 7, the process begins by processing logic selecting PCI Express protocol data or non-PCI Express protocol data to be transmitted on a first set of lanes on a link (processing block 700). If PCI Express protocol data is selected then processing logic transmits PCI Express protocol data on both the first set of link lanes and a second set of link lanes (processing block 702). If PCI Express protocol data is not selected then processing logic transmits non-PCI Express protocol data on the first set of link lanes and PCI Express protocol data on the second set of link lanes (processing block 704) and the process is finished.

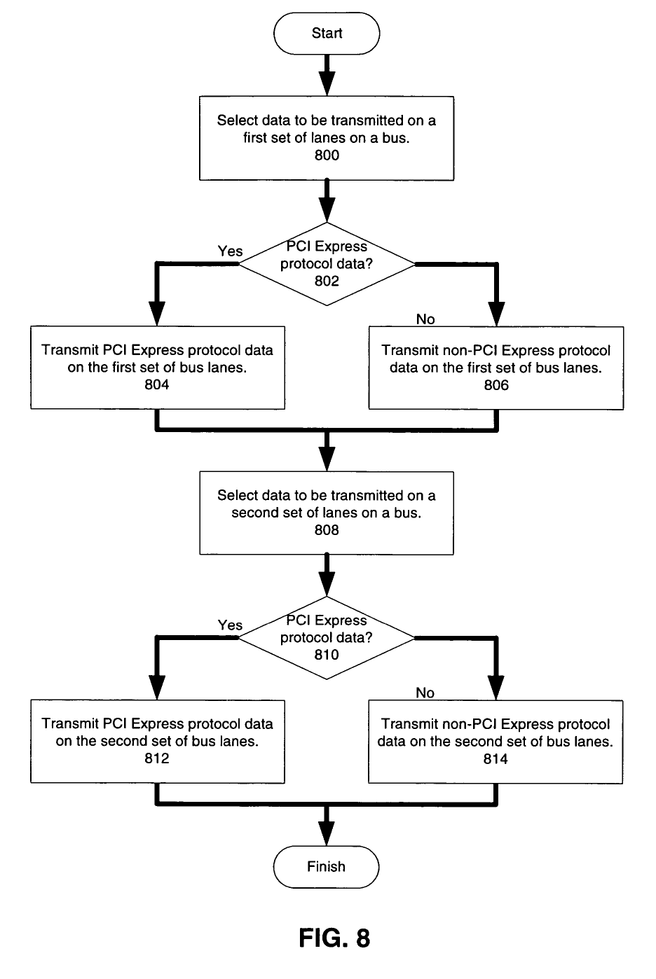

FIG. 8 is a flow diagram of another embodiment of a process for selecting a protocol to be transmitted on a link. The process is performed by processing logic that may comprise hardware (circuitry, dedicated logic, etc.), software (such as is run on a general purpose computer system or a dedicated machine), or a combination of both. Referring to FIG. 8, the process begins by processing logic selecting data to be transmitted on a first set of lanes on a link (processing block 800). Next, processing logic determines if the data selected is PCI Express protocol data (processing block 802). If the data selected is PCI Express protocol data, then processing logic transmits PCI Express protocol data on the first set of link lanes (processing block 804). Otherwise, if the data selected is non-PCI Express protocol data, then processing logic transmits non-PCI Express protocol data on the first set of link lanes (processing block 806). Next, the process continues by processing logic selecting data to be transmitted on a second set of lanes on a link (processing block 808). Then processing logic determines if the data selected is PCI Express protocol data (processing block 810). If the data selected is PCI Express protocol data, then processing logic transmits PCI Express protocol data on the second set of link lanes (processing block 812). Otherwise, if the data selected is non-PCI Express protocol data, then processing logic transmits non-PCI Express protocol data on the second set of link lanes (processing block 814) and the process is finished.

Thus, embodiments of a method to transmit PCI Express protocol data and sDVO protocol data concurrently over a PCI Express link are disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method comprising:
transmitting Peripheral Component Interconnect (PCI) Express protocol data on a first set of one or more lanes of a link; and
concurrently transmitting non-PCI Express protocol data on a second set of one or more lanes of the link.

2. The method of claim 1, wherein the non-PCI Express protocol data further comprises Serial Digital Video Output (sDVO) protocol data.

3. The method of claim 1, wherein the non-PCI Express data further comprises more than one non-PCI Express data protocol.

4. The method of claim 1, wherein the link further comprises a multi-lane serial link.

5. The method of claim 4, wherein each of the first and second sets of lanes comprise eight lanes, such that eight lanes are used for transmission of PCI Express data concurrently with eight lanes being used for transmission of non-PCI Express data.

6. A system, comprising:
a link comprising a plurality of link lanes;
a peripheral device coupled to the link; and
a memory controller coupled to the link, the memory controller operable to concurrently transmit to the peripheral device PCI Express protocol data over the link on one or more lanes and non-PCI Express protocol data over the link on one or more lanes.

7. The system of claim 6, wherein the non-PCI Express protocol data further comprises Serial Digital Video Output (sDVO) protocol data.

8. The system of claim 6, wherein the link further comprises a multi-lane serial link.

9. The system of claim 6, wherein the memory controller is further operable to receive from the peripheral device PCI Express protocol data over the link on one or more link lanes or transmit to the peripheral device PCI Express protocol data over the link on one or more link lanes and concurrently receive non-PCI Express protocol data over the link on one or more link lanes or concurrently transmit non-PCI Express protocol data over the link on one or more link lanes.

10. A system, comprising:
a link comprising a plurality of link lanes;
a memory controller coupled to the link; and
a peripheral device coupled to the link, the peripheral device operable to transmit to the memory controller PCI Express protocol data over the link on one or more lanes and receive non-PCI Express protocol data over the link on one or more lanes.

11. The system of claim 10, wherein the non-PCI Express protocol data further comprises Serial Digital Video Output (sDVO) protocol data.

12. The system of claim 10, wherein the link further comprises a multi-lane serial link.

13. The system of claim 10, wherein the peripheral device is further operable to receive from the peripheral device PCI Express protocol data over the link on one or more link lanes or transmit to the peripheral device PCI Express protocol data over the link on one or more link lanes and concurrently receive non-PCI Express protocol data over the link on one or more link lanes or concurrently transmit non-PCI Express protocol data over the link on one or more link lanes.

14. An apparatus, comprising:
a communication unit operable to concurrently transmit PCI Express protocol data over a first data lane and transmit non-PCI Express protocol data over a second data lane.

15. The apparatus of claim 14, wherein the communication unit is further operable to concurrently receive PCI Express protocol data over the first data lane and receive non-PCI Express protocol data over the second lane.

16. The apparatus of claim 15, wherein the communication unit is further operable to concurrently transmit PCI Express protocol data over the first data lane and receive non-PCI Express protocol data over the second data lane.

17. The apparatus of claim 16, wherein the communication unit is further operable to concurrently receive PCI Express protocol data over the first data lane and transmit non-PCI Express protocol data over the second data lane.

18. The apparatus of claim 17, wherein the non-PCI Express protocol data further comprises Serial Digital Video Output (sDVO) protocol data.

19. The apparatus of claim 17, wherein communication unit transmits and receives data over a multi-lane serial link.

20. A method, comprising:
selecting PCI Express protocol data or non-PCI Express protocol data to be transmitted on a first set of lanes on a link;
transmitting PCI Express protocol data over the first set of link lanes, while transmitting PCI Express protocol data over a second set of lanes on the link, if the PCIExpress protocol data is selected; and
transmitting non-PCI Express protocol data over the first set of link lanes, while transmitting PCI Express protocol data over the second set of link lanes, if the non-PCI Express protocol data is selected.

21. The method of claim 20, wherein the non-PCI Express protocol data further comprises Serial Digital Video Output (sDVO) protocol data.

22. The method of claim 20, wherein the link further comprises a multi-lane serial link.

23. The method of claim 20, further comprising dynamically selecting PCI Express protocol data or non-PCI Express protocol data during data transmission.

24. The method of claim 23, further comprising:
determining the amount of PCI Express data sent across the link over a period of time;
determining the amount of non-PCI Express data sent across the link over the period of time;
increasing the number of lanes selected to transmit using a PCI Express protocol and simultaneously decreasing the number of lanes selected to transmit using a non-PCI Express protocol if the amount of PCI Express protocol data is greater than the amount of non-PCI Express protocol data;
increasing the number of lanes selected to transmit using a non-PCI Express protocol and simultaneously decreasing the number of lanes selected to transmit using a PCI Express protocol if the amount of non-PCI Express protocol data is greater than the amount of PCI Express protocol data.

25. The method of claim 24, wherein increasing the number of lanes selected to transmit using a PCI Express protocol and simultaneously decreasing the number of lanes selected to transmit using a non-PCI Express protocol further comprises increasing the number of lanes selected to transmit using a PCI Express protocol by one lane and simultaneously decreasing the number of lanes selected to transmit using a non-PCI Express protocol by one lane.

26. The method of claim 24, wherein increasing the number of lanes selected to transmit using a non-PCI Express protocol and simultaneously decreasing the number of lanes selected to transmit using a PCI Express protocol further comprises increasing the number of lanes selected to transmit using a non-PCI Express protocol by one lane and simultaneously decreasing the number of lanes selected to transmit using a PCI Express protocol by one lane.

27. The method of claim 24, wherein the period of time is equal to one second.
